(19) United States
(12) Patent Application Publication
(10) Pub. No.: US 2024/0402575 A1
(43) Pub. Date: Dec. 5, 2024

(54) CAMERA MODULE

(71) Applicant: SAMSUNG ELECTRO-MECHANICS CO., LTD., Suwon-si (KR)

(72) Inventor: JINSHENG WANG, Suwon-si (KR)

(73) Assignee: SAMSUNG ELECTRO-MECHANICS CO., LTD., Suwon-si (KR)

(21) Appl. No.: 18/432,619

(22) Filed: Feb. 5, 2024

(30) Foreign Application Priority Data
May 30, 2023 (KR) 10-2023-0069188

(51) Int. Cl. G03B 15/05; G03B 17/12

(52) U.S. Cl. CPC G03B 15/05; G03B 17/12

(57) ABSTRACT

A camera module is provided. The camera module includes a cover including a front cover portion and having an accommodating space therein, a lens barrel disposed within the accommodating space, an image sensor disposed at a rear area of the lens barrel along an optical axis direction of the lens barrel within the accommodating space, and a light emitting portion disposed around the lens barrel, wherein the front cover portion is configured to have a groove portion disposed around the region corresponding to the lens barrel in the optical axis direction.

### CROSS-REFERENCE TO RELATED APPLICATIONS

This application claims the benefit under 35 USC § 119 (a) of Korean Patent Application No. 10-2023-0069188 filed on May 30, 2023, in the Korean Intellectual Property Office, the entire disclosure of which is incorporated herein by reference for all purposes.

### BACKGROUND

### 1. Field

The following description relates to a camera module.

### 2. Description of the Background

An electric camera may be installed in the vehicle in order to recognize the driving environment and the face of the driver, and to record the environment within the vehicle.

Since the inside of the vehicle may be dark, these cameras have embedded light emitting components that operate as lighting.

Additionally, in typical cameras, a method of fixing a lens and light emitting components to a cover made of a non-transmissive material and installing a plate made of a transmissive material on the exterior surface was implemented.

However, depending on the structure of the camera, the light emitted by the light emitting component is reflected from the inside and enters the lens, causing defects such as flare and ghost, which may adversely affect image quality.

Additionally, when a gap is formed between an opaque fixed main body and a plate made of transmissive material of the exterior due to insufficient management of design and size, there is also a risk that reflection may leak through the gap.

Therefore, there is a need to develop a camera module with an integrated cover preventing reflection inside the camera.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a cover comprising a front cover portion, and having an accommodating space therein; a lens barrel disposed within the accommodating space; an image sensor disposed at a rear area of the lens barrel along an optical axis direction of the lens barrel within the accommodating space; and a light emitting portion disposed around the lens barrel, wherein the front cover portion is configured to have a groove portion disposed around a region corresponding to the lens barrel in the optical axis direction.

The groove portion may be disposed to surround the region corresponding to the lens barrel.

The groove portion may be disposed on an inner surface of the front cover portion that faces the lens barrel.

The groove portion may have a wedge-shaped cross-sectional shape.

The groove portion may have a stepped cross-sectional shape.

The groove portion may have a cross-sectional shape comprising a curved line.

The camera module may further include a light blocking portion in which a protrusion portion that is coupled to the groove portion is positioned, wherein the light blocking portion may be disposed to surround the lens barrel in a front area of the lens barrel along the optical axis direction of the lens barrel within the accommodating space.

The protrusion portion may be configured to have a shape that is complementary to a shape of the groove portion.

The light blocking portion may extend in a direction that is vertical to the optical axis direction to surround the light emitting portion.

The light blocking portion may have an opening in which the light emitting portion is accommodated.

The light blocking portion comprises a non-transmissive material.

The light blocking portion may be disposed to contact the lens barrel.

The front cover portion may include a surface treatment portion that is positioned on an inner surface of the front cover portion, and the surface treatment portion may include a non-transmissive material.

The surface treatment portion may be disposed to surround a region corresponding to the lens barrel and the light emitting portion.

The front cover portion may include a transmissive material.

The camera module may further include a first substrate, disposed in the accommodating space, and on which the image sensor is mounted; and a second substrate, disposed on one side of the first substrate, and on which the light emitting portion is mounted.

In a general aspect, a camera module includes a cover comprising a front cover portion, and having an accommodating space therein; a lens barrel disposed within the accommodating space; and a light emitting portion disposed around the lens barrel, wherein the front cover portion is configured to have a groove portion disposed around a region corresponding to the lens barrel in the optical axis direction.

The camera module may further include an image sensor disposed at a rear area of the lens barrel along an optical axis direction of the lens barrel within the accommodating space.

Other features and aspects will be apparent from the following detailed description, the drawings, and the claims.

### BRIEF DESCRIPTION OF DRAWINGS

FIG. 1 is a perspective view schematically illustrating an example camera module, in accordance with one or more embodiments.

FIG. 2 illustrates an exploded perspective view of a part of an example camera module, in accordance with one or more embodiments.

FIG. 3 illustrates a cross-sectional view taken along A-A′ of FIG. 1.

FIG. 4 illustrates a cross-sectional view taken along A-A′ of FIG. 1.

FIG. 5 illustrates a cross-sectional view taken along A-A′ of FIG. 1.

FIG. 6 is a perspective view schematically illustrating an example camera module, in accordance with one or more embodiments.

FIG. 7 illustrates an exploded perspective view of a part of an example camera module, in accordance with one or more embodiments.

FIG. 8 illustrates a cross-sectional view taken along B-B′ of FIG. 6.

FIG. 9 illustrates a top plan view of a front cover portion of an example camera module, in accordance with one or more embodiments.

FIG. 10 illustrates a cross-sectional view taken along B-B′ of FIG. 6.

FIG. 11 illustrates a cross-sectional view taken along B-B′ of FIG. 6.

FIG. 12 illustrates a top plan view of a front cover portion of an example camera module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

One or more examples provide a camera module that prevents defects such as flare and ghost due to light reflections generated inside a camera module.

One or more examples provide a down-sized camera module having an integral appearance including a transmissive material.

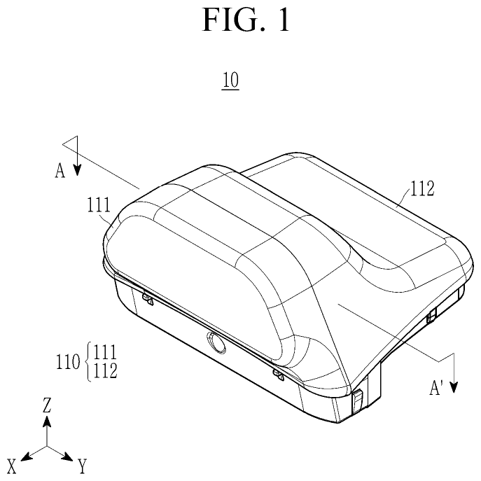

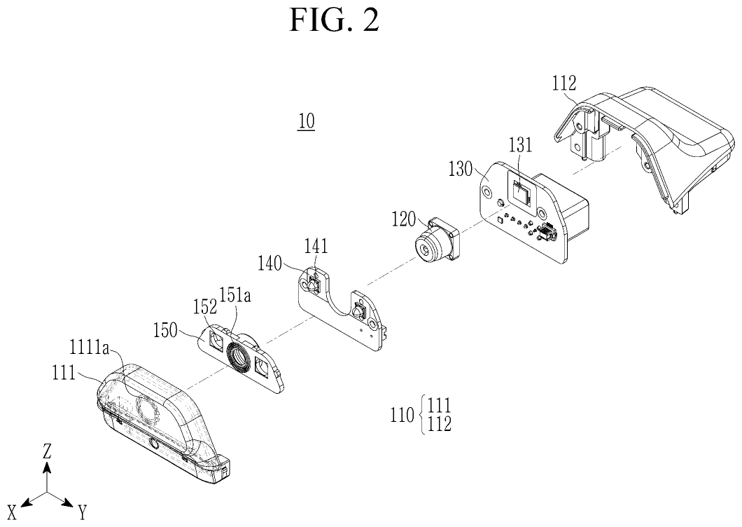

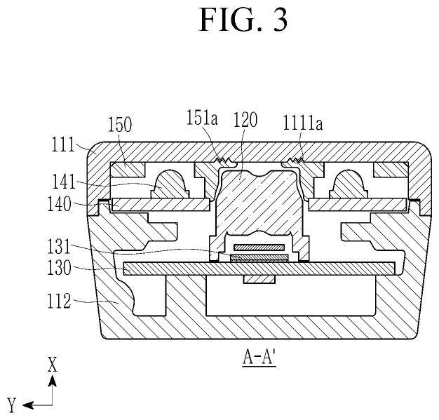

Referring to FIGS. 1 to 3, an example camera module 10, in accordance with one or more embodiments, will be described. FIG. 1 is a perspective view schematically illustrating an example camera module, in accordance with one or more embodiments FIG. 2 illustrates an exploded perspective view of a part of an example camera module, in accordance with one or more embodiments, and FIG. 3 illustrates a cross-sectional view taken along A-A′ of FIG. 1.

First, referring to FIGS. 1 and 2, an example camera module 10, in accordance with one or more embodiments, may include a cover 110, a lens barrel 120, a first substrate 130, a second substrate 140, and a light blocking portion 150. In an example, the camera module 10, in accordance with one or more embodiments, may be implemented in a device that photographs or captures images and monitors a vehicle occupant in order to prevent a vehicle accident.

The cover 110 configures the exterior of the camera module 10, and may accommodate various components of the camera module 10 therein. The cover 110 may block foreign particles such as moisture and dust from flowing into the camera module 10 and may protect components such as the lens barrel 120, the first substrate 130, and the second substrate 140 from external impact.

In an example, the cover 110 may have a polyhedral shape having a substantially quadrangle cross section and a predetermined height. However, the shape of the cover 110 is not limited to a polyhedral shape having a quadrangle cross section.

The cover 110 may include a front cover portion 111 and a rear cover portion 112. The front cover portion 111 may transmit external light into the camera module 10. The front cover portion 111 may include a transmissive material. In an example, the front cover portion 111 may have a shape that is integrated with a transparent material. A rear cover portion 112 is disposed on the rear of the front cover portion 111 and may be coupled to the front cover portion 111.

By coupling the front cover portion 111 and the rear cover portion 112, the cover 110 may have an accommodating space therein. Components such as the lens barrel 120, the first substrate 130, and the second substrate 140 may be accommodated in the accommodating space of the cover 110.

The lens barrel 120 may be disposed within the accommodating space of the cover 110. The lens barrel 120 may include a plurality of lenses disposed along an optical axis direction.

The first substrate 130 may be disposed within the accommodating space of the cover 110. The first substrate 130 may be disposed on the rear along the optical axis direction of the lens barrel 120, and an image sensor 131 may be mounted thereon. The image sensor 131 may be disposed within the accommodating space of the cover 110. The image sensor 131 may be disposed on the rear along the optical axis direction of the lens barrel 120. Light passing through the plurality of lenses included in the lens barrel 120 may be incident to the image sensor 131 provided on the first substrate 130.

The second substrate 140 may be disposed on one side of the lens barrel 120 along the optical axis direction of the first substrate 130. The second substrate 140 may be disposed in the accommodating space of the cover 110. In an example, a light emitting portion 141 may be mounted on the second substrate 140. The light emitting portion 141 may be disposed around the lens barrel 120. The light emitting portion 141 may operate as a lighting component of the camera module 10. In an example, the light emitting portion 141 may include a light emitting diode (LED) or a vertical cavity surface emitting laser (VCSEL), as only examples.

A light blocking portion 150 may be disposed in a front area of the lens barrel 120 along the optical axis direction of the lens barrel 120. The light blocking portion 150 may be positioned within the accommodating space. The light blocking portion 150 may be disposed to surround the lens barrel 120. The light blocking portion 150 blocks light emitted from the light emitting portion 141 and reflected from inside the camera module 10 and being unnecessarily incident on the lens barrel 120, thereby preventing defects such as flare and ghost.

In an example, the light blocking portion 150 may be mutually fixed to the front cover portion 111 through double molding such as adhesive, double-sided adhesive tape, or double injection.

Hereinafter, the front cover portion 111 and the light blocking portion 150 will be described in detail with reference to FIGS. 2 and 3.

The front cover portion 111 may have a groove portion 1111a disposed around a region corresponding to the lens barrel 120 in the optical axis direction.

The groove portion 1111a may be disposed on an inner surface of the front cover portion 111 facing the lens barrel 120. The groove portion 1111a may be disposed to surround a region corresponding to the lens barrel 120 on the inner surface of the front cover portion 111. In an example, the groove portion 1111a may be disposed to surround a region corresponding to the lens barrel 120 on the inner surface of the front cover portion 111 in a circular shape. The groove portion 1111a may have a wedge-shaped cross-sectional shape. For example, the groove portion 1111a may have a cross-sectional shape including at least one wedge-shape.

The light blocking portion 150 may extend in a direction vertical to the optical axis direction. For example, the light blocking portion 150 may be a plate shape having at least one opening. The light blocking portion 150 may extend in a direction vertical to the optical axis direction to surround the light emitting portion 141.

The light blocking portion 150 may have an opening 152 in which the light emitting portion 141 is accommodated. The light blocking portion 150 may include a non-transmissive material.

A protrusion portion 151a coupled to the groove portion 1111a may be positioned in the light blocking portion 150. The protrusion portion 151a may be positioned on one surface of the light blocking portion 150 facing the front cover portion 111.

The protrusion portion 151a may have a shape matching the groove portion 1111a. In other words, the protrusion portion 151a may have a shape that is complementary to the shape of the groove portion 1111a, and the front cover portion 111 and the light blocking portion 150 may be coupled so that the protrusion portion 151a and the groove portion 1111a may be coupled each other. In an example, the protrusion portion 151a may have a wedge-shaped cross-sectional shape that is complementary to the groove portion 1111a. However, the examples are not limited thereto, and the protrusion portion 151a may have any shape that can be coupled to the groove portion 1111a.

As described above, since the protrusion portion 151a that is made of a non-transmissive material may be complementarily coupled to the groove portion 1111a of the front cover portion 111 made of a transmissive material, light emitted from the light emitting portion 141 may be prevented from penetrating the groove portion 1111a, thereby preventing light from being reflected inside the front cover portion 111 and being unnecessarily incident on the lens.

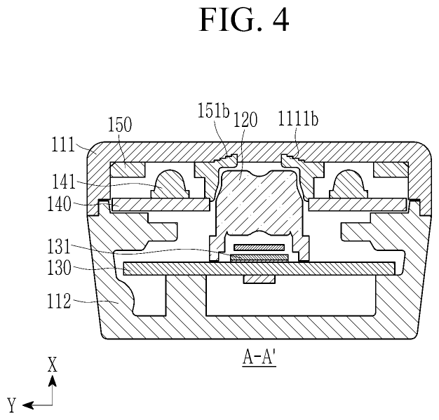

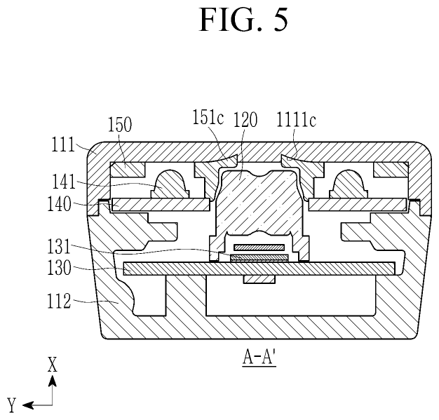

Hereinafter, another embodiment of the groove portion 1111a and the protrusion portion 151a will be described with reference to FIGS. 4 and 5. FIGS. 4 and 5 are cross-sectional views taken along A-A′ of FIG. 1.

Referring to FIG. 4, the example camera module, in accordance with one or more embodiments, is similar to the example camera module 10 according to an embodiment described with reference to FIGS. 1 to 3. A detailed description of the same component is omitted.

Referring to FIG. 4, unlike the camera module 10 according to an embodiment illustrated in FIGS. 1 to 3, a groove portion 1111b of the camera module according to the present embodiment may have a stepped cross-sectional shape. In an example, the groove portion 1111b may have a stepped cross-sectional shape in which the height increases toward the center of the lens barrel 120. A protrusion portion 151b may have a shape that matches the groove portion 1111b. In other words, the protrusion portion 151b may have a shape that is complementary to the shape of the groove portion 1111b. In an example, the protrusion portion 151b may have a stepped cross-sectional shape that is complementary to the shape of the groove portion 1111b.

Referring to FIG. 5, the camera module according to present embodiment is similar to the camera module 10 according to an embodiment described with reference to FIGS. 1 to 3. A detailed description of the same component is omitted.

Referring to FIG. 5, unlike the camera module 10 according to an embodiment shown in FIGS. 1 to 3, a groove portion 1111c of the camera module according to the present embodiment may have a cross-sectional shape including a curved line. In an example, the groove portion 1111c may have a wedge-shaped cross-sectional shape in which the height increases toward the center of the lens barrel 120 and at least one edge is a curved line.

A protrusion portion 151c may have a shape that matches the groove portion 1111c. In other words, the protrusion portion 151c may have a shape that is complementary to the shape of the groove portion 1111c. In an example, the protrusion portion 151c may have a cross-sectional shape including a curved line complementary to the groove portion 1111c.

As described above, by having the front cover portion 111 implemented with the respective groove portions 1111a, 1111b, and 1111c on the inner surface and the light blocking portion 150 with the respective protrusion portions 151a, 151b, and 151c positioned on one surface facing the front cover portion 111, it is possible to implement a higher quality camera by preventing defects such as flare and ghost due to light reflection occurring inside the camera module.

Additionally, it is possible to implement a camera module having an integrated appearance.

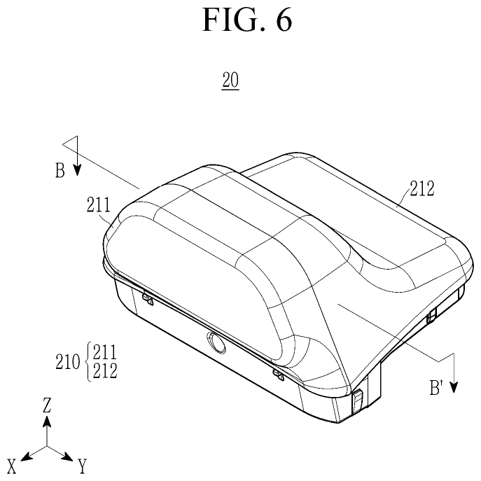

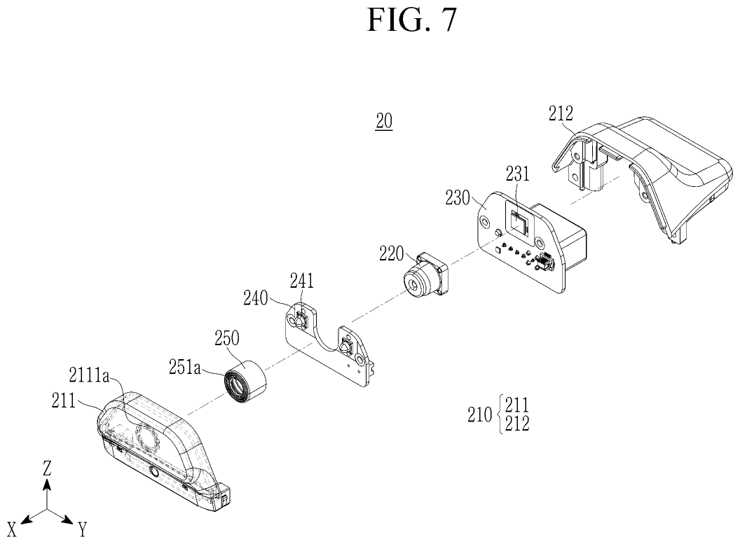

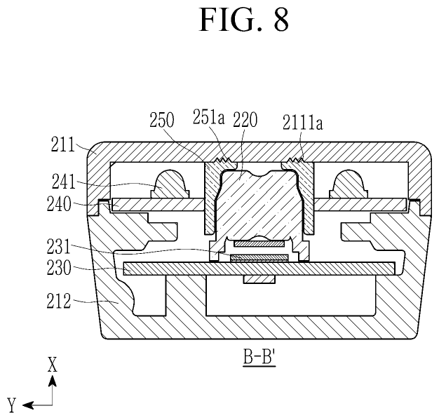

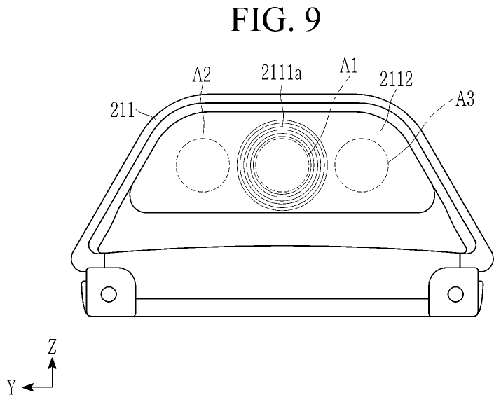

Hereinafter, an example camera module 20, in accordance with one or more embodiments, will be described with reference to FIGS. 6 to 9. FIG. 6 is a perspective view schematically illustrating an example camera module, in accordance with one or more embodiments, FIG. 7 illustrates an exploded perspective view of a part of an example camera module, in accordance with one or more embodiments, FIG. 8 illustrates a cross-sectional view taken along B-B′ of FIG. 6, and FIG. 9 illustrates a top plan view of a front cover portion of an example camera module, in accordance with one or more embodiments.

First, referring to FIGS. 6 and 7, the camera module 20, in accordance with one or more embodiments, may include a cover 210, a lens barrel 220, a first substrate 230, a second substrate 240, and a light blocking portion 250. In an example, the camera module 20, in accordance with one or more embodiments, may be implemented in a device that photographs or captures an image, and monitors a vehicle occupant to prevent a vehicle accident.

The cover 210 configures the exterior of the camera module 20 and may accommodate various components of the camera module 20 therein. The cover 210 blocks foreign particles such as moisture and dust from flowing into the inside of the camera module 20, and may protect components such as the lens barrel 220, the first substrate 230, and the second substrate 240 from external impact.

In an example, the cover 210 may have a polyhedral shape having a substantially quadrangle cross-section and a predetermined height. However, the shape of the cover 210 is not limited to a polyhedral shape having a quadrangle cross-section.

The cover 210 may include a front cover portion 211 and a rear cover portion 212. The front cover portion 211 may transmit external light into the camera module 20. The front cover portion 211 may include a transmissive material. In an example, the front cover portion 211 may have a shape that is integrated with a transparent material. The rear cover portion 212 may be disposed on the rear of the front cover portion 211, and may be coupled to the front cover portion 211.

By coupling the front cover portion 211 and the rear cover portion 212, the cover 210 may have an accommodating space therein. Components such as the lens barrel 220, the first substrate 230, and the second substrate 240 may be accommodated in the accommodating space of the cover 210.

The lens barrel 220 may be disposed within the accommodating space of the cover 210. The lens barrel 220 may include a plurality of lenses disposed along the optical axis direction.

The first substrate 230 may be disposed within the accommodating space of the cover 210. The first substrate 230 may be disposed toward the rear of the lens barrel 220 along the optical axis direction of the lens barrel 220, and an image sensor 231 may be mounted thereon. The image sensor 231 may be disposed within the accommodating space of the cover 210. The image sensor 231 may be disposed on the rear of the first substrate 230 along the optical axis direction of the lens barrel 220. Light passing through the plurality of lenses included in the lens barrel 220 may be incident to the image sensor 231 provided on the first substrate 230.

The second substrate 240 may be disposed on one side of the lens barrel 220 along the optical axis direction of the first substrate 230. The second substrate 240 may be disposed in the accommodating space of the cover 210. A light emitting portion 241 may be mounted on the second substrate 240. The light emitting portion 241 may be disposed around the lens barrel 220. The light emitting portion 241 may operate as a lighting component of the camera module 20. In a non-limited example, the light emitting portion 241 may include a LED or a VCSEL.

The light blocking portion 250 may be disposed in a front area of the of the lens barrel 220, along the optical axis direction of the lens barrel 220. The light blocking portion 250 may be positioned within the accommodating space. In an example, the light blocking portion 250 may be disposed to surround the lens barrel 220. The light blocking portion 250 blocks light emitted from the light emitting portion 241 and reflected from inside the camera module 20 and that is unnecessarily incident on the lens barrel 220, thereby preventing defects such as flare and ghost.

Hereinafter, the front cover portion 211 and the light blocking portion 250 will be described in detail with reference to FIGS. 7 to 9.

The front cover portion 211 may have a groove portion 2111a disposed around a region corresponding in the optical axis direction with the lens barrel 220. The groove portion 2111a may be disposed on an inner surface of the front cover portion 211 facing the lens barrel 220. The groove portion 2111a may be disposed to surround a region corresponding to the lens barrel 220 on the inner surface of the front cover portion 211. In an example, the groove portion 2111a may be disposed to surround a region corresponding to the lens barrel 220 on the inner surface of the front cover portion 211 in a circular shape. In an example, the groove portion 2111a may have a wedge-shaped cross-sectional shape. For example, the groove portion 2111a may have a cross-sectional shape including at least one wedge-shape.

Referring to FIG. 9, the front cover portion 211 may include a surface treatment portion 2112 that is positioned on an inner surface of the front cover portion 211. The surface treatment portion 2112 may include a non-transmissive material. The surface treatment portion 2112 may be disposed around regions A1, A2, and A3, which respectively correspond to the lens barrel 220 and the light emitting portion 241 on the inner surface of the front cover portion 211. Specifically, the surface treatment portion 2112 may be disposed to surround the regions A1, A2, and A3, which correspond to the lens barrel 220 and the light emitting portion 241 on the inner surface of the front cover portion 211. In an example, on the inner surface of the front cover portion 211, the regions A1, A2, and A3, which correspond to the lens barrel 220 and the light emitting portion 241 may be transparent parts including a transmissive material, and the surface treatment portion 2112 disposed to surround the regions A1, A2, and A3 corresponding to the lens barrel 220 and the light emitting portion 241 may be an opaque part including a non-transmissive material. The regions A1, A2, and A3, which correspond to the lens barrel 220 and the light emitting portion 241 on the inner surface of the front cover portion 211 may be mirror-finished. Accordingly, it is possible to prevent light emitted from the light emitting portion 241 from being reflected from inside the front cover portion 211 and being unnecessarily incident on the lens.

The light blocking portion 250 may be disposed to contact the lens barrel 220. The light blocking portion 250 may protrude in the optical axis direction to surround the lens barrel 220.

A protrusion portion 251a coupled to the groove 2111a may be positioned in the light blocking portion 250. The protrusion portion 251a may be positioned on one surface of the light blocking portion 250 facing the front cover portion 211. The protrusion portion 251a may have a shape that matches the groove portion 2111a. In other words, the protrusion portion 251a may have a shape that is complementary to the shape of the groove portion 2111a, and the front cover portion 211 and the light blocking portion 250 may be coupled so that the protrusion portion 251a and the groove portion 2111a may be coupled to each other. In an example, the protrusion portion 251a may have a wedge-shaped cross-sectional shape that is complementary to the shape of the groove portion 2111a. However, it is not limited thereto, and the protrusion portion 251a may have any shape that can be coupled to the groove portion 2111a.

As described above, as the protrusion portion 251a made of a non-transmissive material complementarily couples to the groove portion 2111a of the front cover portion 211 made of a transmissive material, light emitted from the light emitting portion 241 may be prevented from penetrating the groove portion 2111a, thereby preventing light from being reflected inside the front cover portion 211 and being unnecessarily incident on the lens.

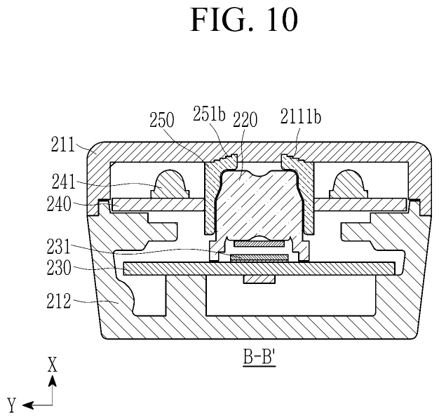

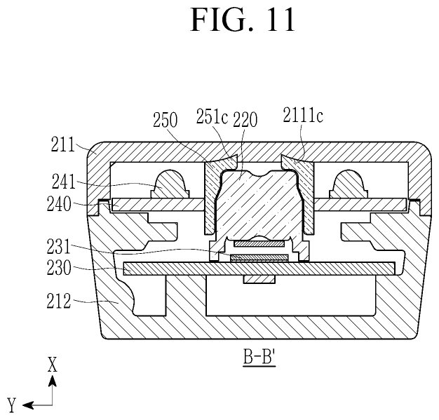

Hereinafter, another embodiment of the groove portion 2111a and the protrusion portion 251a will be described with reference to FIGS. 10 and 11. FIGS. 10 and 11 are cross-sectional views taken along B-B′ of FIG. 6.

Referring to FIG. 10, the camera module, in accordance with one or more embodiments, is similar to the camera module 20 according to another embodiment described with reference to FIGS. 6 to 9. A detailed description of the same component is omitted.

Referring to FIG. 10, unlike the camera module 20 according to another embodiment shown in FIGS. 6 to 9, a groove portion 2111b of the camera module according to the present embodiment may have a stepped cross-sectional shape. In an example, the groove portion 2111b may have a stepped cross-sectional shape in which the height increases toward the center of the lens barrel 220. A protrusion portion 251b may have a shape that matches the groove portion 2111b. In other words, the protrusion portion 251b may have a shape that is complementary to the shape of the groove portion 2111b. In an example, the protrusion portion 251b may have a stepped cross-sectional shape that is complementary to the shape of the groove 2111b.

Referring to FIG. 11, the camera module, in accordance with one or more embodiments, is similar to the camera module 20 according to another embodiment described with reference to FIGS. 6 to 9. A detailed description of the constituent element is omitted.

Referring to FIG. 11, unlike the camera module 20 according to another embodiment shown in FIGS. 6 to 9, the camera module according to the present embodiment may have a cross-sectional shape in which a groove portion 2111c includes a curved line. In an example, the groove portion 2111c may have a wedge-shaped cross-sectional shape in which the height increases toward the center of the lens barrel 220 and at least one edge is a curved line. A protrusion portion 251c may have a shape that matches the groove portion 2111c. In other words, the protrusion portion 251c may have a shape that is complementary to the shape of the groove portion 2111c. In an example, the protrusion portion 251c may have a cross-sectional shape including a curved line that is complementary to the shape of the groove portion 2111c.

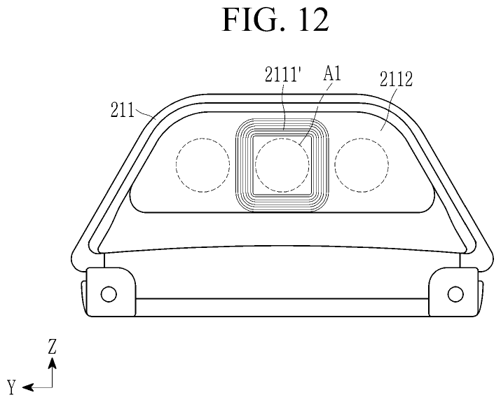

FIG. 12 is a top plan view of a front cover portion of a camera module according to another embodiment.

Referring to FIG. 12, the camera module, in accordance with one or more embodiments, is similar to the camera module 20 according to another embodiment described with reference to FIGS. 6 to 9. A detailed description of the same component is omitted.

Referring to FIG. 12, unlike the groove portion of the camera module 20 according to another embodiment shown in FIGS. 6 to 9, a groove portion 2111′ of the camera module according to another embodiment may be disposed to surround the region A1 corresponding to the lens barrel 220 on the inner surface of the front cover portion 211 in a substantially quadrangle shape. However, the example is not limited thereto, and any shape may be used as long as it can surround the region A1 corresponding to the lens barrel 220 on the inner surface of the front cover portion 211.

As described above, by having the front cover portion 211 with the respective groove portions 2111a, 2111b, and 2111c on the inner surface and the light blocking portion 250 with the respective protrusion portions 251a, 251b, and 251c positioned on one surface facing the front cover portion 211, it is possible to implement a higher quality camera by preventing defects such as flare and ghost due to light reflection occurring inside the camera module.

In addition, it is possible to implement a down-sized camera module having an integrated appearance.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a cover comprising a front cover portion, and having an accommodating space therein;
a lens barrel disposed within the accommodating space;
an image sensor disposed at a rear area of the lens barrel along an optical axis direction of the lens barrel within the accommodating space; and
a light emitting portion disposed around the lens barrel,
wherein the front cover portion has a groove portion disposed around a region corresponding to the lens barrel in the optical axis direction.

2. The camera module of claim 1, wherein:
the groove portion is disposed to surround the region corresponding to the lens barrel.

3. The camera module of claim 1, wherein:
the groove portion is disposed on an inner surface of the front cover portion that faces the lens barrel.

4. The camera module of claim 1, wherein:
the groove portion has a wedge-shaped cross-sectional shape.

5. The camera module of claim 1, wherein:
the groove portion has a stepped cross-sectional shape.

6. The camera module of claim 1, wherein:
the groove portion has a cross-sectional shape comprising a curved line.

7. The camera module of claim 1, further comprising:
a light blocking portion in which a protrusion portion that is coupled to the groove portion is positioned,
wherein the light blocking portion is disposed to surround the lens barrel in a front area of the lens barrel along the optical axis direction of the lens barrel within the accommodating space.

8. The camera module of claim 7, wherein:
the protrusion portion is configured to have a shape that is complementary to a shape of the groove portion.

9. The camera module of claim 7, wherein:
the light blocking portion extends in a direction that is vertical to the optical axis direction to surround the light emitting portion.

10. The camera module of claim 9, wherein:
the light blocking portion has an opening in which the light emitting portion is accommodated.

11. The camera module of claim 9, wherein:
the light blocking portion comprises a non-transmissive material.

12. The camera module of claim 7, wherein:
the light blocking portion is disposed to contact the lens barrel.

13. The camera module of claim 7, wherein:
the front cover portion comprises a surface treatment portion that is positioned on an inner surface of the front cover portion, and the surface treatment portion comprises a non-transmissive material.

14. The camera module of claim 13, wherein:
the surface treatment portion is disposed to surround the region corresponding to the lens barrel and the light emitting portion.

15. The camera module of claim 1, wherein:
the front cover portion comprises a transmissive material.

16. The camera module of claim 1, further comprising:
a first substrate, disposed in the accommodating space, and on which the image sensor is mounted; and
a second substrate, disposed on one side of the first substrate, and on which the light emitting portion is mounted.

17. A camera module, comprising:
a cover comprising a front cover portion, and having an accommodating space therein;
a lens barrel disposed within the accommodating space; and
a light emitting portion disposed around the lens barrel,
wherein the front cover portion has a groove portion disposed around a region corresponding to the lens barrel in the optical axis direction.

18. The camera module of claim 17, further comprising an image sensor disposed at a rear area of the lens barrel along an optical axis direction of the lens barrel within the accommodating space.
